(19) United States
(12) Patent Application Publication
(10) Pub. No.: US 2006/0254018 A1
(43) Pub. Date: Nov. 16, 2006

(54) Method for producing a wiper arm, especially for window wiper systems in vehicles

(76) Inventor: Manfred Losch, Bietigheim-Bissingen (DE)

Correspondence Address: MATTHEW R. JENKINS, ESQ., 2310 FAR HILLS BUILDING, DAYTON, OH, 45419, US

(21) Appl. No.: 10/567,281

(22) PCT Filed: Aug. 3, 2004
(86) PCT No.: PCT/EP04/08675

§ 371 Date: Feb. 3, 2006

(30) Foreign Application Priority Data
Aug. 6, 2003 (DE) 103 35 853.6

(51) Int. Cl. B60S 1/34

(52) U.S. Cl. 15/250.351; 15/250.352; 29/897.2; 29/897

(57) ABSTRACT

The invention relates to a method for producing a wiper arm for window wiping systems in vehicles. According to the invention, an articulated part of a wiper arm is stamped out of a one-sided sheet metal material which is pre-coated on one side, and is then bent in a mold having a U-shaped cross-section. In this way, the coated surface forms the inner side of the articulated part of the wiper arm. Said articulated part is then joined to a wiper arm fixing part by means of a hinge bolt, and the wiper arm is then provided with a layer of paint by means of a spraying or powder technique.

The invention relates to a method for producing a wiper arm, especially for window wiping systems in vehicles.

A wiper arm consists of a wiper arm fixing part, a wiper arm articulated part, which is joined in an articulated manner to the wiper arm fixing part, and a wiper blade which is held on the wiper arm articulated part. A tension spring which is suspended between the wiper arm fixing part and the wiper arm articulated part provides the bearing pressure with which the wiper blade bears against the surface of the window. At its end remote from the wiper arm articulated part, the wiper arm fixing part is placed on the wiper shaft and fixed to the latter.

The wiper arm fixing part is usually a die-cast metal part, in particular a die-cast part made of zinc or aluminum. By contrast, the wiper arm articulated part is made of sheet steel. During production of the wiper arm, its individual components are assembled before the entire wiper arm is painted. In principle, various painting methods can be used to paint a wiper arm. However, on account of the aforementioned production process which requires assembly of the wiper arm prior to painting, those painting methods in which complete coating is not ensured must be ruled out. However, in the articulated region of the wiper arm, the inner surfaces of the wiper arm articulated part lie close against the outer surface of the wiper arm fixing part and form a narrow gap at that point. If a continuous coating, in particular of the wiper arm articulated part made from sheet steel, is not ensured in this gap, corrosion may occur which leads to malfunctions. This is because the corrosion gives rise to an increase in friction in the articulated region, as a result of which there is a reduction in the pressing force with which the wiper blade presses against the surface of the window. Such a reduction in the pressing force results in the functioning of the wiper arm being put at risk.

For this reason, in professional circles, it is assumed that a dipping technique must be used to paint the finished, assembled wiper arm. Compared to other painting methods such as wet spray painting or powder coating, dip coating has the advantage that even hidden surfaces are reliably reached by the paint particles and thus a continuous coating is ensured.

On the other hand, the use of dip coating requires a high investment which results in increased manufacturing costs overall. As an alternative to dip coating, separate pre-painting of the wiper arm articulated part can be considered. However, this is also expensive; it leads to the painting costs being more or less doubled. Moreover, higher paint waste levels are obtained, along with a higher power requirement, so that there are also considerations with regard to the environment.

By virtue of the method according to the invention, freedom from corrosion in the articulated region of the wiper arm is ensured without cost-intensive dip coating. According to the invention, in a first step the wiper arm articulated part is stamped out of a sheet metal material which is precoated on one side. In the next step, the stamped part is bent in such a way that the coated surface is placed on the inside. The wiper arm fixing part is then joined to the wiper arm articulated part by means of a hinge pin. The wiper arm is then painted by means of a spraying or powder technique, wherein account can be taken of the fact that hidden surface areas are not or are not fully reached by the paint layer. The inner surfaces of the wiper arm articulated part which bear against the wiper arm fixing part or are placed at a narrow spacing therefrom are provided with the precoating of the sheet metal material, so that they are protected against corrosion. An appreciable advantage over the competition is achieved by omitting the investment costs required for a dip coating system.

Sheet metal material which is precoated on one side is known as “coil coating” material. This strip material which is coated on one side and is supplied on rolls is currently used for example in the production of washing machines, but in a material thickness of up to 0.5 mm, which is insufficient for a wiper arm. In the method according to the invention, a coil coating material having a thickness of 1.2 to 2 mm is used.

In the preferred embodiment of the method, the wiper arm articulated part is bent in the form of a U-shaped channel. In this form, it is particularly suitable for producing a modern wiper arm with a flat wiper blade.

Further advantages and features of the invention emerge from the following description and from the appended drawings. In the drawings:

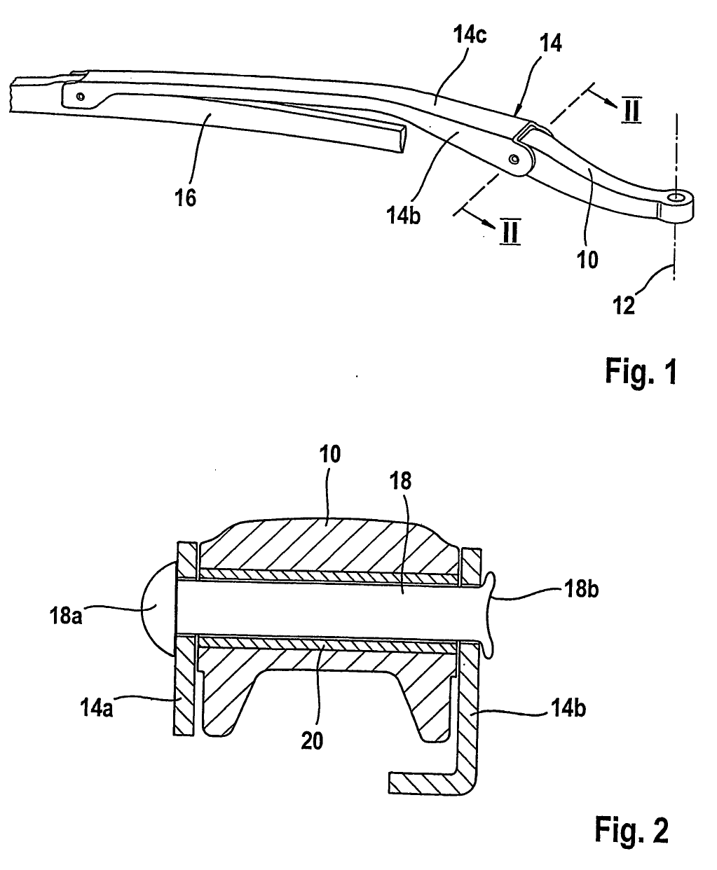

FIG. 1 shows a schematic perspective view of a wiper arm;

FIG. 2 shows a section along line II-II in FIG. 1; and

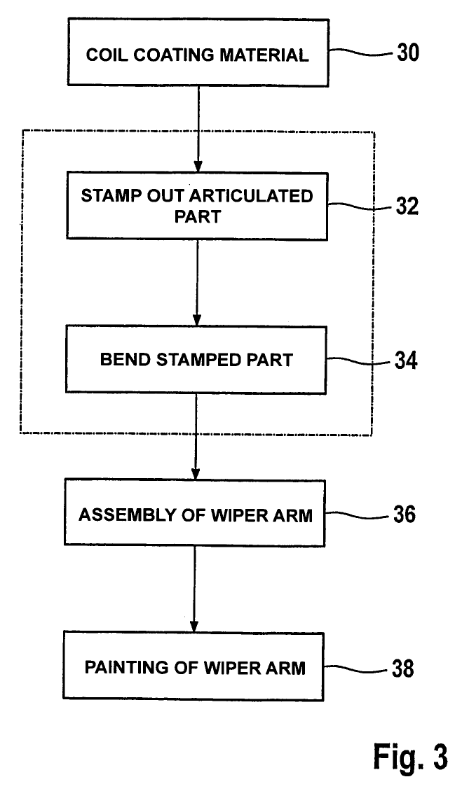

FIG. 3 shows a flow chart illustrating the production of the wiper arm.

The wiper arm shown by way of example in FIG. 1 for the window wiping system of a motor vehicle is a modern design with a flat wiper blade. It consists essentially of a wiper arm fixing part 10 which is fixed at one axial end on a wiper shaft 12, a wiper arm articulated part 14 which is connected in an articulated manner to the other end of the wiper arm fixing part 10, and a wiper blade 16 which is connected in an articulated manner to the end of the wiper arm articulated part 14 remote from the wiper arm fixing part 10.

The wiper arm articulated part 14 has in cross section the form of a U-shaped channel with two parallel legs 14a, 14b and a web 14c connecting the latter. The articulated connection between the wiper arm fixing part 10 and the wiper arm articulated part 14 is shown on an enlarged scale in FIG. 2.

As can be seen from FIG. 2, the legs 14a, 14b have aligned holes, through which a rivet 18 is inserted. The rivet 18 has a rivet head 18a at the side of leg 14a and a clinched area 18b at the opposite end. The rivet 18 projects through a bearing bushing 20 which is pressed into a through-hole in the wiper arm fixing part 10. It can be seen in the diagram that the legs 14a, 14b are hidden on their inner side by the body of the wiper arm fixing part 10, with conditions being made even more difficult by the fact that the leg 14b has an angled end which serves as a stop for delimiting the folded-out position of the wiper arm. Since the wiper arm articulated part 14 is made from sheet steel, it must be painted to protect it against corrosion. The inner surfaces of the legs 14a, 14b are critical, since these bear against the side surfaces of the wiper arm fixing part 10 which are made from a die-cast metal part, for example a die-cast part made of zinc or aluminum. Corrosion on the inner surfaces of the legs 14a, 14b leads to an increase in the friction between the articulated part and the fixing part, as a result of which the ease of movement of the articulated connection is impaired. This results in a reduction in the pressing pressure with which the wiper blade 16 presses against the window to be wiped, said pressure being generated by a tension spring (not shown in the drawing) suspended between the articulated part and the fixing part. This may result in an impaired or even failed wiping function.

Since the painting of the wiper arm takes place in the assembled state of the wiper arm fixing part 10 and the wiper arm articulated part 14, according to the current prior art it is only possible to use dip coating, by means of which reliable paint application even to hidden surfaces is ensured, so that corrosion of the inner surfaces of the articulated part is reliably prevented.

In the method according to the invention, the wiper arm articulated part 14 is produced from a sheet metal material which is precoated on one side. Accordingly, the first step 30 in FIG. 3 consists in providing a sheet metal material which is precoated on one side, this also being known as “coil coating material”. In this material, the sheet steel is primed on one side and provided with a coating consisting of a paint system which may be the same paint system as that used to paint wiper arms. Unlike conventional coil coating material, the material used in the method according to the invention has a thickness of approximately 1.2 to approximately 2 mm, compared to conventional material thicknesses of for example 0.4 mm.

In the second step 32, an articulated part blank is stamped out of the coil coating material; in the third step 34, the stamped part is bent and brought into the form seen in FIG. 1. In the process, the coated side of the coil coating material forms the inner surface of the wiper arm articulated part 14. The wiper arm is then assembled in step 36. In the final step 38, the entire wiper arm is painted, wherein a conventional spraying method or powder coating can be used. Although it is not ensured here that the hidden inner surfaces of the wiper arm articulated part 14 will receive an application of paint, this is nevertheless not important since these surfaces are already provided with the coating of the coil coating material.

1. A method for producing a wiper arm, especially for window wiping systems in vehicles, comprising a wiper arm fixing part and a wiper arm articulated part, characterized in that the wiper arm articulated part is stamped out of a sheet metal material which is precoated on one side, and then is bent in such a way that the coated surface is placed on the inside, in that the wiper arm fixing part is joined to the wiper arm articulated part by means of a hinge pin, and in that the wiper arm is then provided with a layer of paint by means of a spraying or powder technique.

2. The method as claimed in claim 1, characterized in that the wiper arm articulated part is produced from a precoated sheet metal material having a thickness of approximately 1.2 to approximately 2 mm.

3. The method as claimed in claim 1, characterized in that the wiper arm articulated part is bent so that it has a cross section in the form of a U-shaped channel.

4. The method as claimed in, claim 1, characterized in that a coil coating material is used as the sheet metal material which is precoated on one side.

5. The method as claimed in claim 1, characterized in that the wiper arm fixing part is designed as a die-cast metal part.

6. The method as claimed in claim 5, characterized in that the wiper arm fixing part is designed with a bearing bushing for the passage of the bearing pin.

7. The method as claimed in claim 2, characterized in that the bearing pin projects through the parallel legs of the wiper arm articulated part and is designed as a rivet with a rivet head at one end and a clinched area at the other axial end.

8. A wiper arm with a flat wiper blade, comprising a wiper arm fixing part and a wiper arm articulated part which is joined to the latter by a hinge pin, said wiper arm articulated part having a cross section in the form of a generally U-shaped channel, characterized in that the wiper arm articulated part is made from a sheet metal material which is precoated on one side and has a thickness of approximately 1.2 to approximately 2 mm, and the coated surface is arranged on the inside.
